(19) United States
(12) Patent Application Publication
(10) Pub. No.: US 2019/0057336 A1
(43) Pub. Date: Feb. 21, 2019

(54) non-emergent medical transportation for rural areas lacking road and map infrastructure

(71) Applicants: Jeanna Elizabeth Clark, Seattle, WA (US); James Clark, Seattle, WA (US); Elizabeth Deming Hammar, Seattle, WA (US)

(72) Inventors: Jeanna Elizabeth Clark, Seattle, WA (US); James Clark, Seattle, WA (US); Elizabeth Deming Hammar, Seattle, WA (US)

(21) Appl. No.: 15/682,474

(22) Filed: Aug. 21, 2017

(51) Int. Cl. G06Q 10/06; G06Q 50/22; G01C 21/20

(52) U.S. Cl. CPC G06Q 10/06311; G01C 21/20; G06Q 50/22

(57) ABSTRACT

A means of transportation for rural villages in areas that lack roads and street addressing. Motorbike ambulances traverse the roadless terrain enroute to pick up patients from a predetermined location using global position coordinates. The patient can request this non-emergent medical transportation using cellular phone and/or sending physical communication to the nearest established medical clinic. Established clinics are expanding their geographic reach with this novel form of non-emergent medical transportation that can service rural areas that lack road and map infrastructure.

### BACKGROUND OF THE INVENTION

Emergent and non-emergent medical transportation does not exist in rural areas of developing countries. This fact leads to the atrocity that treatable diseases are terminal in most of these resource poor regions. This is due to established medical clinics being a many days walk from a patient's village, making them practically impossible to reach for maternal mothers, elderly and handicapped as there is no infrastructure to support vehicles. Additionally, most men and contributors to the local economy cannot afford to take a few days off to walk to and from the nearest established medical clinic, so they forgo all medical treatment, leading to extreme cases of disability and disease progression that is not comprehensible to regions that do not have these barriers to healthcare access.

The lack of road and map infrastructure directly influences rural village resident's access to healthcare. There are no personal or public vehicles available to transport patients to and from established medical clinics, so these individuals currently have two options. The first is to simply forego medical treatment and the second is to be transported by a family member to the medical clinic on an animal, wheelbarrow, or cart. This problem directly contributes to premature deaths, high infant and mother mortality rates, low life expectancy, and decreased economic gross domestic product.

### DESCRIPTION OF THE DRAWINGS

FIG. 1 is a pictorial diagram illustrating components for transporting patients from multiple nodes by way of non-emergent medical transportation system for rural areas lacking road and map infrastructure in accordance with the present disclosure.

FIG. 2 is a pictorial diagram illustrating a motorbike ambulance with an onboard global position system and driver transporting a patient between nodes of the non-emergent medical transportation system for rural areas lacking road and map infrastructure in accordance with the present disclosure.

FIG. 3 is a block diagram of components of a dedicated network for a non-emergent medical transportation system for rural areas lacking road and map infrastructure in accordance with the present disclosure.

FIG. 4 is a flow diagram of an illustrative process for controlling the transportation of a rural patient from their origin to the clinic or hospital destination using a non-emergent medical transportation for rural areas lacking road and map infrastructure in accordance with the present disclosure.

### DESCRIPTION OF THE INVENTION

As is set forth in greater detail below, the present disclosure is directed to providing a dedicated, non-emergent medical transportation for rural areas that lack road and map infrastructure. Such systems may be provided for the delivery and pick-up of patients to and from rural villages that lack public and private transportation methods. In accordance with the present disclosure, a dedicated non-emergent transportation system may include multiple or single nodes meaning multiple established clinics running motorbike ambulances to and from villages for patient pick-up or a single clinic running multiple motorbikes from it's single clinic location.

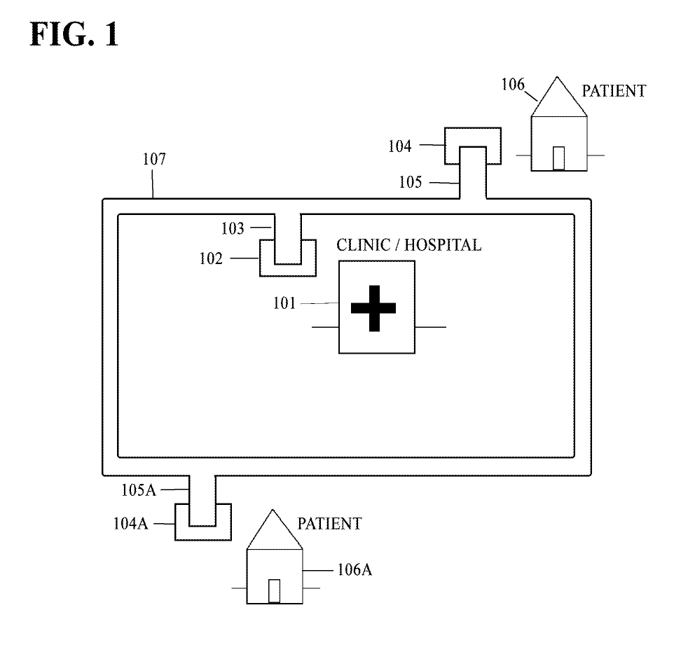

The systems and methods of the present disclosure thus enable the delivery of patients to and from their home village and an established medical clinic. The geographic area of the patient's home village and medical clinic must be relatively nearby (e.g., within the confines of a motorbike ambulance's fuel capacity). The geographic area is known to lack roads and map addresses, so global position coordinates will be used to relay patient location to established clinic and in turn the motorbike ambulance driver. Referring to FIG. 1, a pictorial diagram illustrates components for transporting patients from multiple nodes by way of non-emergent medical transportation system for rural areas lacking road and map infrastructure in accordance with the present disclosure. 101 is the established medical clinic in the transportation system. 102 represents the global position coordinates for the clinic, and 103 represents the cellular telephone associated with the clinic. 105 represents the cellular telephone associated with the patient, and 104 represents the global position coordinates for the patient. 106 represents the patient's home in their rural village. 107 represents the non-emergent medical transportation system network connecting the patient to the clinic by way of motorbike ambulance. 104A, 105A, and 106A represent another patient node which is a mirror of the aforementioned 104, 105, and 106 components, showing that each clinic is able to service multiple patients in multiple villages.

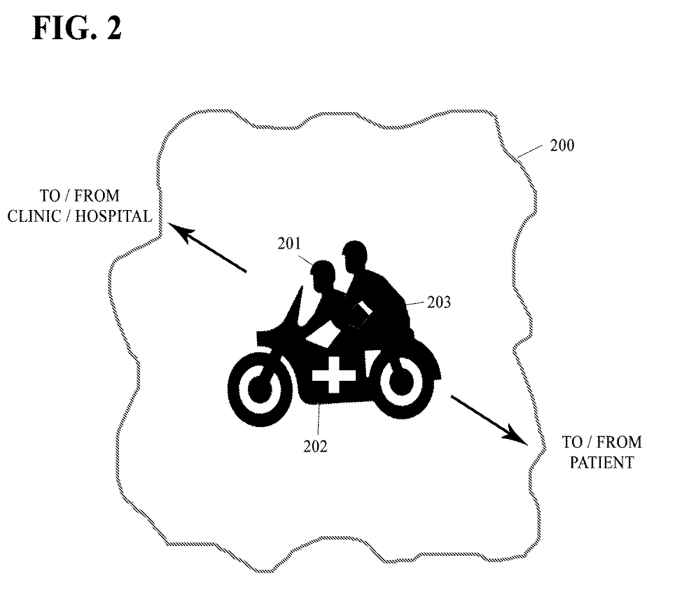

As is shown in FIG. 2, a pictorial diagram illustrating a motorbike ambulance with an onboard global position system and driver transporting a patient between nodes of the non-emergent medical transportation system for rural areas lacking road and map infrastructure in accordance with the present disclosure. System 200 represents the patient motorbike transport system in areas that lack road and map infrastructure. 201 represents the clinic staff person who operates the motorbike. This motorbike operator departed from the clinic and arrived at the patient location, traversing roadless terrain. This motorbike operator navigated using global position coordinates on mobile device, and this operator loaded the patient into the motorbike ambulance sidecar. 203 represents the patient, and 202 represents the motorbike ambulance. The motorbike operator will transport the patient to and from the medical clinic for treatment.

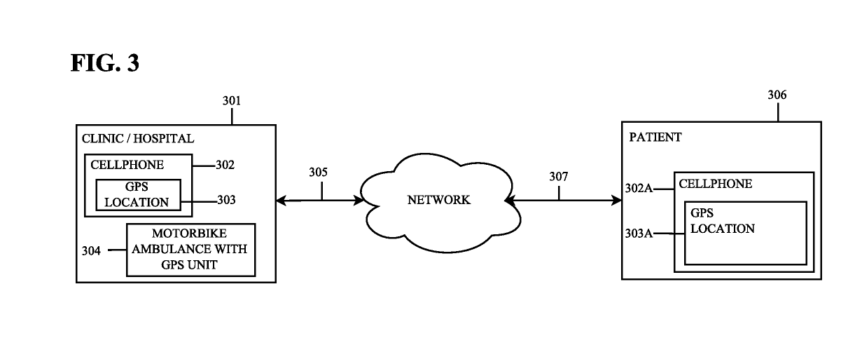

As is shown in FIG. 3, a block diagram of components of a dedicated network for a non-emergent medical transportation system for rural areas lacking road and map infrastructure in accordance with the present disclosure. This diagram maps the network that is described in FIG. 1. 301 represents the established clinic. 302 represents the clinic's telephone, and 303 represents the associated global position coordinates for the clinic. 304 represents the motorbike ambulance that is operated by the clinic. 306 represents a patient who is located in a rural area that lacks road and map infrastructure and is in need of non-emergent medical care. 302A and 303A mirror 302 and 303, and they represent the patient's telephone global position coordinates respectively. 305 and 307 represent the network connections required for the clinic and patient telephones to communicate respectively.

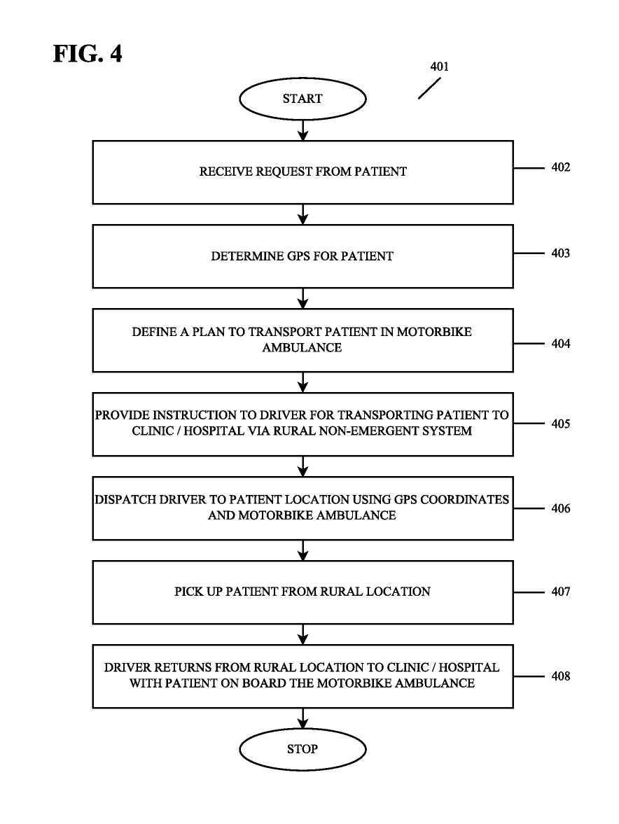

Referring to FIG. 4, a flow diagram of an illustrative process for controlling the transportation of a rural patient from their origin to the clinic or hospital destination using a non-emergent medical transportation for rural areas lacking road and map infrastructure in accordance with the present disclosure. System 401 represents the process works. 402 is when the clinic receives the telephone request from a patient for non-emergent medical transportation to their village's current global position coordinates. 403 shows that the patient's data has been successfully transmitted and received by the clinic, and the clinic is locating the patient on their global position map. 404 demonstrates the clinic's motorbike ambulance operators development of a travel plan to traverse the terrain that lacks roads and maps to pickup the patient. 405 represents the clinic staffs approval of the ambulance operators travel plan to pick up the patient. 406 demonstrates the motorbike ambulance operator being dispatched from the clinic to pick up the patient at their provided global position coordinates location. 407 represents the patient being picked up by the motorbike ambulance operator from their rural village. 408 represents the driver returning to the rural village with the patient on board the motorbike ambulance's sidecar.

Therefore, according to the present disclosure, a network non-emergent medical transportation system may comprise multiple clinics and/or multiple motorbikes. Although the invention has been described and illustrated with respect to illustrative embodiments thereof, the foregoing and various other additions and omissions may be made therein and thereto without departing from the spirit and scope of the present disclosure.

What is claimed is:

1. A rural non-emergent medical transportation network comprising:
an established rural medical clinic or hospital who owns a cellular telephone with global position coordinate functionality; and
a community of people living within a specified radius of said clinic or hospital who owns a cellular telephone with global position coordinate functionality; and
no road or map infrastructure between said clinic or hospital and said community of people

2. The rural non-emergent medical transportation network of claim 1, wherein said established rural medical clinic or hospital owns and operates a functional motorbike ambulance.

3. The rural non-emergent medical transportation network of claim 2, wherein said established rural medical clinic or hospital dispatches a motorbike ambulance with driver to the provided global position coordinates of the established community of people living within a specified radius of said clinic or hospital. The driver will transport the patient back to the clinic for treatment and then will transport the patient back to their village community.
